(19) United States
(12) Patent Application Publication
(10) Pub. No.: US 2007/0237497 A1
(43) Pub. Date: Oct. 11, 2007

(54) Means for influencing the temperature of flowable media, especially of lubricants found in a lubricant system

(76) Inventor: Frank Gunter Lehmann, Spiesen-Elversberg (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/401,481

(22) Filed: Apr. 11, 2006

(30) Foreign Application Priority Data
Apr. 4, 2006 (DE) 10 2006 015 601.3

(51) Int. Cl. H05B 3/60

(52) U.S. Cl. 392/314

(57) ABSTRACT

A means for influencing the temperature of flowable media, especially of lubricants found in a lubricant system, having a line through which the medium flows and at least one element (11) which is assigned to the line section (1, 5) for influencing the temperature and which can be activated by supplying energy, characterized in that at least one element (11) is located within the line section (1, 5) in the flow path of the medium and that the wall of the line section (1, 5) has a connecting means (9) for supplying energy to at least one element (11) located in the line section (1, 5).

The invention relates to a means for influencing the temperature of flowable media, especially of lubricants found in a lubricant system, having a line through which the medium flows and at least one element which is assigned to the line section for influencing the temperature and which can be activated by supplying energy.

Means of this type can be used for example in mechanical systems, especially in large machines, when operating states must be expected there in which for flowable operating media, for example lubricating oils, temperatures occur which lead to an unfavorable operating behavior, specifically an overly great viscosity. These operating states, as can occur during cold running phases of certain systems or specifically in wind power plants under winter conditions, make it difficult to transport the operating media, for example the lubricant circulation. For this reason, on a certain line section, for example on the lubricant line which leads from a mechanism via a pump and via filter means and the like back to the mechanism, there are conventionally means with elements for increasing or also reducing the temperature of the flowing media.

Known means of this type are made such that on the indicated line section one or more elements (heating elements, cooling elements) for influencing the temperature are attached on the outside wall and can be activated as necessary. In order to achieve a sufficient action for the medium located within the line section, it is necessary in this connection to provide external insulation which encompasses the line section and which lies over the elements in order to prevent excess losses to the outside. Aside from the fact that in spite of insulating outside jacketing in this connection sufficient efficiency is not achieved when the temperature of the inner medium is influenced, the external insulation jacketing leads to an awkwardly shaped outside contour of the line section which requires a large amount of space so that installation in mechanical systems under narrowed installation conditions becomes very difficult. Efficiency is especially low when the elements are attached to a nonmetallic line section, for example to an oil intake tube via which lubricating oil from the mechanism is intaken by means of a pump.

With respect to this prior art, the object of the invention is to devise a means for influencing the temperature which is characterized not only by comparatively far better efficiency, but also by an especially space-saving construction.

This object is achieved as claimed in the invention by a means which has the features of claim 1 in its entirety.

Because in the invention at least one temperature-influencing element is located within the medium-carrying line section and can be supplied with energy via a connecting means which is located in the wall of the line section, on the one hand losses are prevented which arise in the prior art by heat transfers between the temperature-influencing elements located on the outside wall of the line section to the vicinity, even if there is complex external insulation over the elements. On the other hand, efficiency is very greatly improved as a result of the direct heat transfer between the medium and the elements placed in its flow path. Since moreover in the means as claimed in the invention the necessity is obviated of awkwardly shaped external insulation which surrounds the line section and the elements located outside on it, the means as claimed in the invention is also characterized by an especially compact, space-saving construction, so that the means can also be used without difficulty in mechanical systems where narrowed space conditions prevail and little installation space is available.

Preferably at least one temperature-influencing element is located within an element unit, and the connecting means is made such that it forms a holding device for fixing the position of the element unit.

In the cases in which there is a means for raising the temperature of the pertinent media and the element unit is accordingly a heating unit which contains at least one heating element which can be activated by electrical energy, for especially advantageous exemplary embodiments the arrangement is such that the heating unit has at least one heating strip which extends in the longitudinal direction of the line section and which is intended as a heating element.

Heating strips in the form of self-regulating surface heating strips are known and are commercially available. The self-regulating property enables use of such heating strips without the need for electrical control means. Since these heating strips are moreover available in any desired length, these heating strips are especially well suited for use in the means as claimed in the invention.

In heating strips, even if they have a multilayer structure in the conventional manner and an outside protective jacket of polyolefin, in conjunction with certain media (oils) over very long operating intervals the protective jacket of the heating strips can be adversely affected. In an especially advantageous exemplary embodiment of the invention it is therefore provided that the heating unit containing at least one heating strip has a shell which surrounds at least one heating strip and which seals it against the medium.

This can advantageously be a corrugated tube of high-quality steel which is welded tight on one end and is connected to the connecting means on its other end.

Here the arrangement can be made such that the connecting means has a pipe union which is located on one end region of the line section and through which the assigned end of the corrugated tube extends.

This end of the corrugated tube can be welded to a sleeve-like adapter which with the interposition of a seal arrangement can be screwed to the outer end area of the pipe union which can form a penetration for a connecting cable for power supply of at least one heating strip which is located in the corrugated tube.

In the corrugated tube there are preferably two heating strips which run longitudinally and which are held spaced apart from one another by a separating element which extends between them, so that the thermal influence of the heating strips on one another and thus any adverse effect on the self-regulating property of each individual heating strip are avoided.

In exemplary embodiments in which the line section can be an oil intake tube, therefore a component with nonmetallic wall, the arrangement is preferably made such that the line section has a metallic elbow which is bent relative to the longitudinal axis of the intake tube and which is connected to the oil intake tube, and that on the elbow there is a pipe union, the pipe union preferably extending in the direction of the longitudinal axis of the intake tube, so that the corrugated tube which has been screwed to the pipe union is fixed in the position which extends in the direction of the longitudinal axis of the intake tube.

The invention is explained below in detail with reference to an exemplary embodiment shown in the drawings, in which

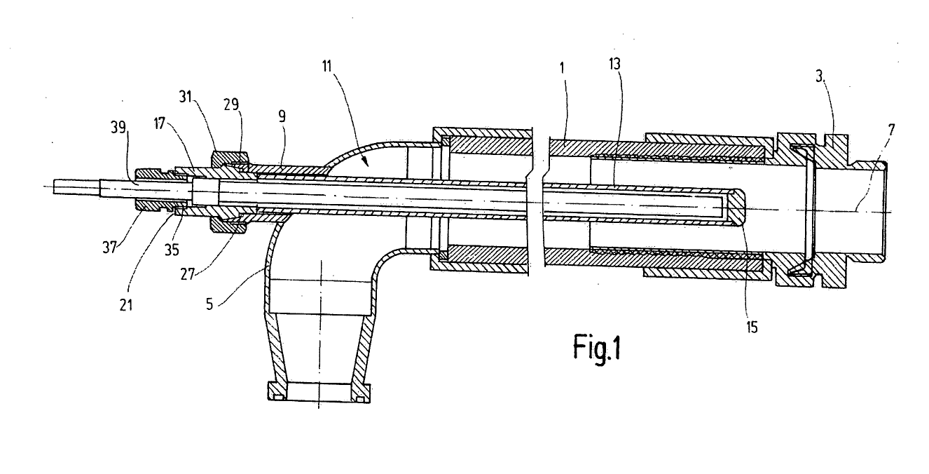

FIG. 1 shows a shortened longitudinal section of one exemplary embodiment of the means as claimed in the invention, the illustrated exemplary embodiment being made for increasing the temperature of the lubricating oil which is flowing through an oil intake tube;

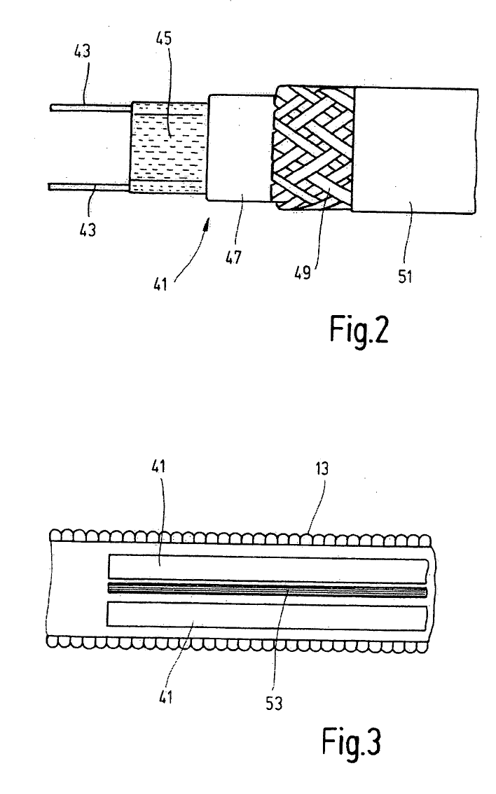

FIG. 2 shows a dismounted view of a heating strip which is shown slightly enlarged compared to a practical embodiment and partially cut through for use in the means as claimed in the invention;

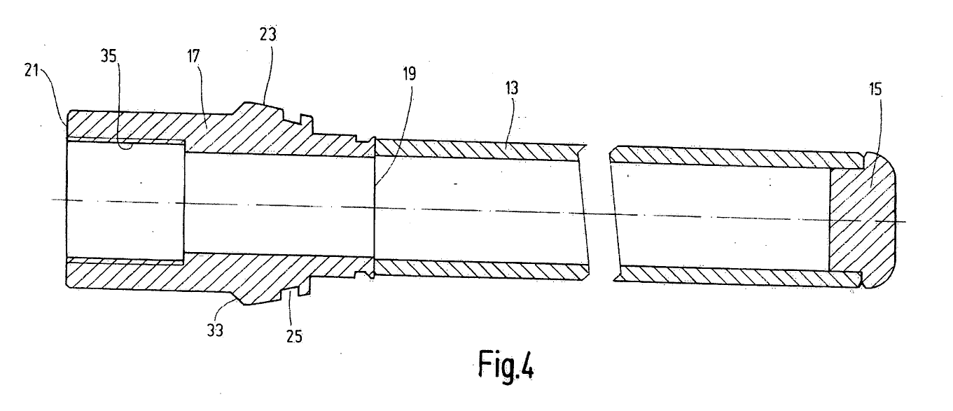

FIG. 3 shows a highly schematically simplified sketch simply for illustration of the positioning of the two heating strips which are drawn on a smaller scale compared to FIG. 2, within the shell of the heating unit provided in the exemplary embodiment of the invention and

FIG. 4 shows a longitudinal section of simply the shell of the heating unit, drawn isolated and enlarged compared to FIG. 1 and to one practical embodiment.

The invention is explained below with reference to the drawings using one exemplary embodiment in which there is a means for increasing the temperature of the lubricating oil which is flowing through the intake tube 1. The nonmetallic intake tube 1 made in the conventional manner is connected on one end by means of a connecting fitting 3 to a mechanism which is not shown and on the opposite end has a metallic pipe elbow 5 which is bent at a right angle relative to the longitudinal axis 7 of the intake tube 1 and leads to a pump which is not shown, which sucks the lubricating oil out of the mechanism and forms part of a pertinent lubricant circuit.

As access to the line section formed by the intake tube 1 and the elbow 5, a pipe union 9 is welded to the elbow 5 such that it forms a passage with an axis which coincides with the longitudinal axis 7 of the intake tube 1. An elongated heating unit labeled 11 as a whole extends through the passage formed by the pipe union 9 into the interior of the intake tube 1 along the axis 7 into the vicinity of the end-side connecting fitting 3. The heating unit 11 has a corrugated tube 13 of conventional design of high grade steel as a shell which seals the interior of the heating unit 11 fluid-tight against the surrounding lubricating oil. The corrugated tube 13 which is shown separately and enlarged in FIG. 4 is welded fluid-tight to the closure body 15 on the end which has been placed on the right in the drawings. On the other incoming end assigned to the pipe union 9, the corrugated tube 13 is welded to a sleeve-like adapter 17 at the weld 19. In a longitudinal section placed between the outer end 21 and the weld 19 the adapter 17 has a thickened area with a conical surface 23 which is tilted to the inside in the direction to the weld 19 and in which an annular groove 25 is made for a gasket which is not shown in FIG. 4.

FIG. 1 shows the heating unit 11 in the installed state, the corrugated tube 13 extending into the pipe union 9 which forms a holder for the heating unit 11, i.e. with its inside wall aligns the corrugated tube 13 so that it extends along the axis 7 in the intake tube 1. In the outside edge area the pipe union 9 has a conical surface which is complementary to the conical surface 23 of the adapter 17, which in the installed state is adjoined by the conical surface 23 of the adapter 17, and which is sealed thereon via the gasket 27 (FIG. 1) which sits in the annular groove 25. The outer end section of the pipe union 9 has an outside thread 29 in order to screw the adapter to the pipe union by means of a union nut 31 which is supported on the annular shoulder 33 (FIG. 4) of the adapter 17.

As is best shown in FIG. 4, the adapter 17 on its open end 21 has an inner widened area with an inside thread 35 into which a hollow threaded plug 37 can be screwed which is part of the penetration of an electrical connecting cable in the form of a so-called oil connection 39. Electrical power supply of the heating elements located in the heating unit 11 within the corrugated tube 13 takes place via this connection 39.

Details of the structure and the arrangement of the heating elements can be taken from FIGS. 2 and 3. FIG. 2 shows the structure of a heating strip which is intended for use in the invention, which is labeled 41 as a whole in FIG. 2 and in the conventional manner has two electrical leads 43 which run at a distance from one another and between which there is strip-like material 45 which in the conventional manner forms a self-regulating resistance element between the conductors 43. As is known, the electrical resistance of the material 45 has a positive temperature coefficient so that with rising temperature of the material 45 the strength of the current flowing between the conductors 43 decreases and self-limitation of the heating action occurs. Since heating strips 41 are available in any length, the power and temperature ranges desired at the time can be accommodated without the need for control means.

As can be taken from FIG. 2, the heating strip 41 is made such that the self-regulating material 45 is surrounded by an electrical insulating jacket 47. The latter in turn is enclosed by a protective braid 49 of galvanized copper litz wire. This braid is used for grounding (protective conductor) of the heating strip, protects individuals according to VDE (Association of German Electrical Engineers) Standards, and offers additional mechanical protection. An outside jacket 51 of polyolefin forms the outer termination of the structure.

In this example the heating unit 11 has two heating strips 41 which are located running longitudinally within the corrugated tube 13 and which, as the outline sketch from FIG. 3 illustrates, are thermally insulated from one another by a joint strip 53 which runs longitudinally between them. This thermal decoupling of the heating strips 41 prevents the temperatures of the two strips from being mutually brought to bear and thus the intensity of the heating output, a function of the temperature of the surrounding medium, is not influenced by the other heating strip. The use of heating strips 41 is advantageous in several respects. Thus, based on the self-limitation of power, use without a temperature limiter is possible. The heating strips 41 can be cut off in any length to adapt to the pertinent conditions of use by the parallel current supply.

A joint strip 53 in the form of precompressed polyurethane foam has proven especially effective as the separating element between the heating strips 41. In particular, it can be an open-cell polyurethane soft foam, impregnated with a synthetic resin made flame-retardant.

1. Means for influencing the temperature of flowable media, especially of lubricants found in a lubricant system, having a line through which the medium flows and at least one element (41) which is assigned to the line section (1, 5) for influencing the temperature and which can be activated by supplying energy, characterized in that at least one element (41) is located within the line section in the flow path of the medium and that the wall of the line section (1, 5) has a connecting means (9) for supply of energy to at least one element (41) located in the line section (1, 5).

2. Means as claimed in claim 1, wherein at least one element (41) is located within the element unit (11) and wherein the connecting means (9) forms a holder for positioning of the element unit (41).

3. Means as claimed in claim 2, wherein the element unit has a heating unit (11) which contains at least one heating element (41) which can be activated by electrical energy.

4. Means as claimed in claim 3, wherein the heating unit (11) has at least one heating strip (41) which extends in the longitudinal direction of the line section (1, 5) and which is designed as a heating element.

5. Means as claimed in claim 4, wherein the heating unit (11) has a shell (13) which surrounds at least one heating strip (41) and which seals it against the medium.

6. Means as claimed in claim 5, wherein the shell is a corrugated tube (13) of high-quality steel which is welded tight on one end (15) and which is connected to the connecting means (9) on its other end (21).

7. Means as claimed in claim 6, wherein the connecting means has a pipe union (9) which is located on one end area (5) of the line section (1, 5) and through which the assigned end (21) of the corrugated tube (13) extends.

8. Means as claimed in claim 7, wherein the end (21) of the corrugated tube (13) assigned to the pipe union (9) is welded to a sleeve-like adapter (17) which can be screwed to the outer end area of the pipe union (9) with the interposition of a seal arrangement (27).

9. Means as claimed in claim 8, wherein the adapter (17) forms a penetration for a connecting cable (39) for power supply of at least one heating strip (41) which is located in the corrugated tube (13).

10. Means as claimed in claim 9, wherein in the corrugated tube (13) there are two heating strips (41) which run longitudinally and which are held spaced apart from one another by a separating element (53) which extends between them.

11. Means as claimed in claim 7, wherein the line section (1, 5) has an oil intake tube (1) and a metallic elbow (5) which is bent relative to the longitudinal axis (7) of the intake tube (1) and which is connected to the latter, and wherein on the elbow there is a pipe union (9).

12. Means as claimed in claim 11, wherein the pipe union (9) extends in the direction of the longitudinal axis (7) of the intake tube (1).
